(19) United States
(12) Patent Application Publication
(10) Pub. No.: US 2025/0219485 A1
(43) Pub. Date: Jul. 3, 2025

(54) ROTOR, ELECTRIC MOTOR, FAN, VENTILATOR, AND AIR CONDITIONER

(71) Applicant: Mitsubishi Electric Corporation, Tokyo (JP)

(72) Inventors: Kazuhiko BABA, Tokyo (JP); Atsushi MATSUOKA, Tokyo (JP); Junichi OZAKI, Tokyo (JP)

(21) Appl. No.: 18/704,714

(22) PCT Filed: Dec. 28, 2021
(86) PCT No.: PCT/JP2021/048762

§ 371 Date: Apr. 25, 2024

(51) Int. Cl. H02K 1/272; H02K 1/02; H02K 5/16; H02K 7/14

(52) U.S. Cl. CPC H02K 1/272; H02K 1/02; H02K 5/161; H02K 7/14

(57) ABSTRACT

A rotor includes an outer rotor part and an inner rotor part provided inside the outer rotor part. The outer rotor part is a bonded magnet with a relative permittivity larger than 40 and equal to or smaller than 200. The inner rotor part is an insulating material with a relative permittivity equal to or smaller than 10. The rotor satisfies D2=D3 and 0.15≤(D3−D4)/(D1−D2), where D1 is an outer diameter of the outer rotor part, D2 is an inner diameter of the outer rotor part, D3 is an outer diameter of the inner rotor part, and D4 is an inner diameter of the inner rotor part.

### TECHNICAL FIELD

The present disclosure relates to a rotor, an electric motor, a fan, a ventilator, and an air conditioner.

### BACKGROUND ART

A technology is proposed to prevent electrolytic corrosion in a bearing by adjusting the rotor capacitance from 3 pF to 12 pF by adjusting the dielectric constant of a resin magnet such as a bonded magnet, which constitute the rotating body of an electric motor, to 10 or more and 40 or less (see, for example, Patent Reference 1).

### PRIOR ART REFERENCE

### Patent Reference

Patent Reference 1: International Publication No. WO 2013/042282

### SUMMARY OF THE INVENTION

### Problem to be Solved by the Invention

In general, when a rotor is constituted of a bonded magnet with a relative permittivity is larger than 40, the voltage generated between the inner and outer rings of a bearing (hereafter also referred to as “bearing voltage”) increases, and thus the discharge current flowing in the bearing increases. As a result, electrolytic corrosion occurs in the bearing, and thus vibration and noise in the electric motor is disadvantageously increased.

To solve the above problem, it is an object of the present disclosure to reduce bearing voltage, suppress a discharge current flowing in a bearing, and suppress the increase in vibration and noise of an electric motor, even when a bonded magnet with a relative permittivity larger than 40 are used in the rotor.

### Means of Solving the Problem

A rotor of the present disclosure includes:
an outer rotor part; and
an inner rotor part provided inside the outer rotor part, wherein
the outer rotor part is a bonded magnet, a relative permittivity of the bonded magnet being larger than 40 and equal to or smaller than 200,
the inner rotor part is an insulating material, a relative permittivity of the insulating material being equal to or smaller than 10, and
the rotor satisfies D2=D3 and 0.15≤(D3−D4)/(D1−D2),
where D1 is an outer diameter of the outer rotor part, D2 is an inner diameter of the outer rotor part, D3 is an outer diameter of the inner rotor part, and D4 is an inner diameter of the inner rotor part.

An electric motor of the present disclosure includes:
a stator; and
the rotor disposed inside the stator.

A fan according to another aspect of the present disclosure includes:
a blade; and
the electric motor to rotate the blade.

A ventilator according to another aspect of the present disclosure includes:
a blade; and
the electric motor to rotate the blade.

An air conditioner according to another aspect of the present disclosure includes:
an indoor unit; and
an outdoor unit to be connected to the indoor unit,
wherein the indoor unit, the outdoor unit, or each of the indoor unit and the outdoor unit includes the electric motor.

### Effects of the Invention

According to the present disclosure, it is possible to reduce bearing voltage, suppress a discharge current flowing in a bearing, and suppress the increase in vibration and noise of an electric motor, even when a bonded magnet with a relative permittivity larger than 40 are used in the rotor.

### BRIEF DESCRIPTION OF THE DRAWINGS

FIG. 1 is a cross-sectional view schematically showing an electric motor according to a first embodiment.

FIG. 2 is a perspective view schematically showing a stator.

FIG. 3 is a circuit diagram showing an example of an electric circuitry.

FIG. 4 is a cross-sectional view schematically showing the structure of a rotating body.

FIG. 5 is a graph showing the reduction rate of bearing voltage in the electric motor according to the first embodiment with respect to an electric motor under comparison.

FIG. 6 is a diagram schematically showing a fan according to a second embodiment.

FIG. 7 is a diagram schematically showing a ventilator according to a third embodiment.

FIG. 8 is a diagram schematically showing the configuration of an air conditioner according to a fourth embodiment.

### MODE FOR CARRYING OUT THE INVENTION

### First Embodiment

The electric motor 1 according to a first embodiment will be described hereafter.

In an xyz orthogonal coordinate system shown in each drawing, a z-axis direction (z-axis) represents a direction parallel to the axis A1 of the electric motor 1, an x-axis direction (x-axis) represents a direction orthogonal to the z-axis direction, and a y-axis direction (y-axis) represents a direction orthogonal to both the z-axis direction and the x-axis direction. The axis A1 refers to the rotation center of a rotor 2, that is, the rotation axis of the rotor 2. The direction parallel to the axis A1 is also referred to as the “axial direction of the rotor 2” or simply the “axial direction.” A radial direction refers to a direction along a radius of the rotor 2, a stator 3, or a stator core 31, and refers to a direction orthogonal to the axis A1. An xy plane refers to a plane orthogonal to the axial direction. A circumferential direction of the rotor 2, the stator 3, or the stator core 31 is also simply referred to as the “circumferential direction.”

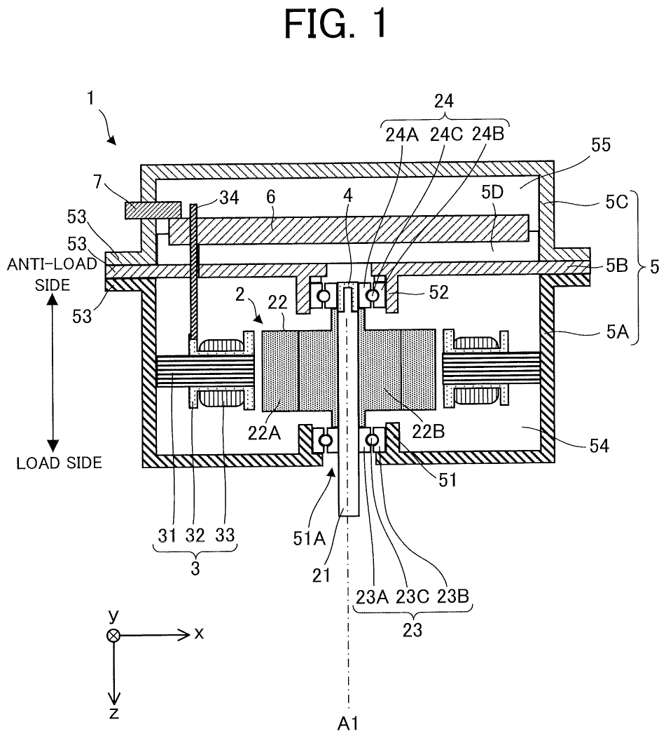

FIG. 1 is a cross-sectional view schematically showing the electric motor 1 according to the first embodiment.

The electric motor 1 includes the rotor 2, the stator 3, a non-conductive member 4, and a conductive housing 5. The electric motor 1 is, for example, a permanent magnet synchronous motor.

As shown in FIG. 1, the electric motor 1 may further include electric circuitry 6 and a connector 7. The rotor 2 and the stator 3 are disposed in the conductive housing 5.

As shown in FIG. 1, the stator 3 includes the stator core 31, at least one insulator 32, at least one coil 33, and at least one conductive pin 34. Each coil 33 is wound on the insulator 32. The stator 3 is press-fitted into a frame 5A of the conductive housing 5. That is, the outer peripheral surface of the stator 3 (e.g., the outer peripheral surface of the stator core 31) is in contact with the conductive housing 5.

### Stator 3

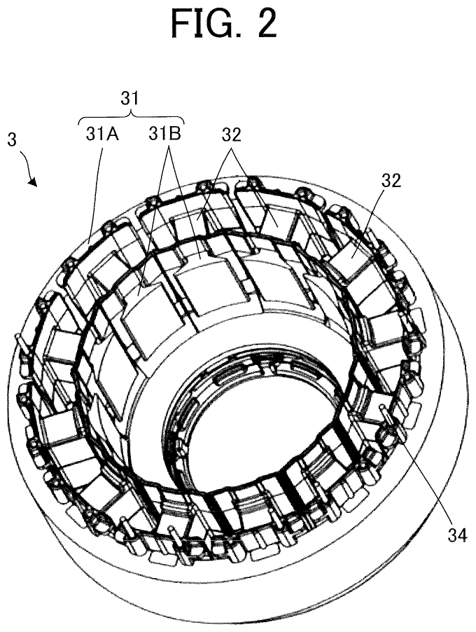

FIG. 2 is a perspective view schematically showing the stator 3.

In FIG. 2, the coil 33 is removed from the stator 3 to show the structure of the stator core 31 and the insulator 32.

The stator core 31 includes a yoke 31A extending in the circumferential direction and a plurality of teeth 31B. In the present embodiment, the stator core 31 includes 12 teeth 31B. Each of the teeth 31B extends in the radial direction from the yoke 31A. The stator core 31 is a cylindrical core. For example, the stator core 31 is formed of a plurality of electrical steel sheets laminated in the axial direction. In this case, each of the plurality of electrical steel sheets is formed into a predetermined shape with blanking. These electrical steel sheets are fixed to each other by caulking, welding, gluing, or the like.

The coil 33 is a three-phase coil with U-phase, V-phase, and W-phase.

Each insulator 32 is provided on the tooth 31B. Each insulator 32 is a thermoplastic resin, such as polybutylene terephthalate (PBT), etc. Each insulator 32 electrically insulates the stator core 31 (specifically, each of the teeth 31B of the stator core 31). For example, the insulator 32 is unitedly molded with the stator core 31. However, the insulator 32 may be molded in advance, and the molded insulator 32 may be combined with the stator core 31.

Each conductive pin 34 is fixed to the insulator 32, for example. Each conductive pin 34 electrically connects the coil 33 and the electric circuitry 6. Specifically, each conductive pin 34 electrically connects the coil 33 and a switching circuit 64b of an inverter circuit 64 of the electric circuitry 6.

### Electric Circuitry 6

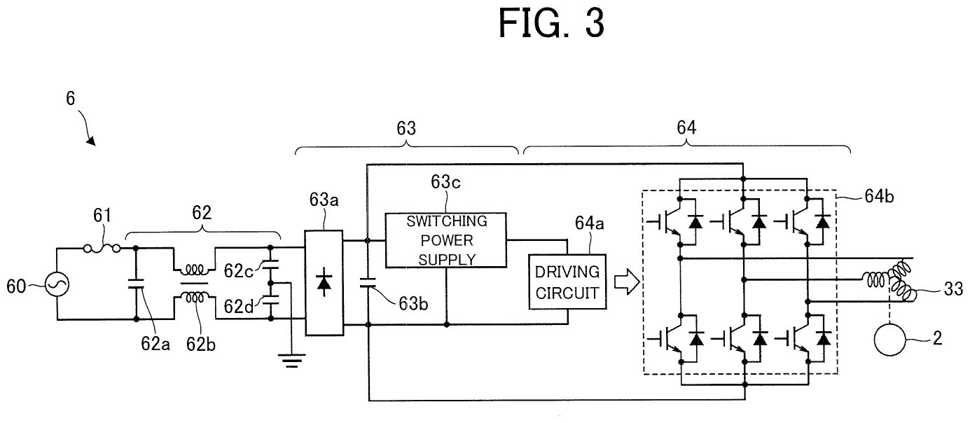

FIG. 3 is a circuit diagram showing an example of the electric circuitry 6.

In the example shown in FIG. 3, the electric circuitry 6 includes a fuse 61, a filter circuit 62, a power circuit 63, and an inverter circuit 64. The electric circuitry 6 is configured to be electrically connected to an AC power source 60.

When an AC current (e.g., 100 VAC to 240 VAC) is supplied to the electric circuitry 6 from the AC power source 60, the AC current is supplied to the power circuit 63 through the fuse 61 and the filter circuit 62. The AC current is converted to a DC current by the power circuit 63.

The filter circuit 62 includes a capacitor 62a, a common mode choke coil 62b, and Y capacitors 62c and 62d. With this configuration, the filter circuit 62 composes a noise filter.

The power circuit 63 includes a rectifier circuit 63a, a smoothing capacitor 63b, and a switching power supply 63c. In the power circuit 63, an AC current input through the filter circuit 62 is full-wave rectified by the rectifier circuit 63a having a diode bridge and converted into a DC current. The DC current is accumulated in the smoothing capacitor 63b. In the smoothing capacitor 63b, the DC current (e.g., 140 VDC or 280 VDC) required at the switching circuit 64b is generated. The switching power supply 63c uses the DC current generated in the smoothing capacitor 63b to generate the control power (e.g., 15 VDC) required at a driving circuit 64a.

The inverter circuit 64 includes a driving circuit 64a and a switching circuit 64b. The switching circuit 64b composes a three-phase bridge, which having U-phase, V-phase, and W-phase, formed between the positive and negative bus bars. The positive bus bar is connected to the positive terminal of the smoothing capacitor 63b, and the negative bus bar is connected to the negative terminal of the smoothing capacitor 63b. The three transistors on the positive bus bar side are upper arm transistors. The three transistors on the negative bus bar side are lower arm transistors. Each switching device is connected to a reflux diode in reverse parallel. The respective end connections of the upper-arm and lower-arm transistors compose output ends and are connected to the U-phase, the V-phase, and the W-phase of the coil 33, respectively.

The driving circuit 64a generates PWM signals to drive the six switching devices of the switching circuit 64b on and off.

In the present embodiment, for example, the electric motor 1 is driven by magnetic pole position sensorless drive without a magnetic pole position sensor such as a Hall IC. In this case, the electric motor 1 includes a magnetic pole position estimation means for estimating the magnetic pole position of the rotor 2. The magnetic pole position estimation means estimates the position of the rotor 2 from a current flowing in the coil 33 and a motor constant, and generates PWM signals to control a current supplied to each phase of the coil 33. As a result, the rotor 2 rotates.

### Rotor 2

The rotor 2 is rotatably disposed inside the stator 3. An air gap exists between the rotor 2 and the stator 3. The rotor 2 includes a conductive shaft 21, a rotating body 22, and first and second bearings 23, 24 that rotatably support the conductive shaft 21. The rotor 2 is rotatable about the rotation axis (i.e., axis A1).

The rotating body 22 is fixed to the conductive shaft 21. The rotating body 22 is located between the first bearing 23 and the second bearing 24. The conductive shaft 21 is rotatably supported by the first bearing 23 and the second bearing 24. The conductive shaft 21 is made of metal, such as, for example, iron.

The first bearing 23 is located on the load side of the electric motor 1 from the rotating body 22. The first bearing 23 rotatably supports the load side of the conductive shaft 21. The second bearing 24 is located on the anti-load side of the electric motor 1 from the rotating body 22. The second bearing 24 rotatably supports the anti-load side of the conductive shaft 21.

In the example shown in FIG. 1, the load side of the conductive shaft 21 protrudes outside the conductive housing 5, and the anti-load side of the conductive shaft 21 does not protrude outside the conductive housing 5.

In the present embodiment, the anti-load side of the conductive shaft 21 does not protrude outside the conductive housing 5, but the anti-load side of the conductive shaft 21 may protrude outside the conductive housing 5.

In the example shown in FIG. 1, the outer diameter of the end of the conductive shaft 21 at the anti-load side is smaller than the outer diameter of the rest of the conductive shaft 21. The non-conductive member 4 covers the end of the conductive shaft 21 at the anti-load side. For example, a blade is provided on the load side of the conductive shaft 21 to generate airflow.

Since the non-conductive member 4 covers the end of the conductive shaft 21 at the anti-load side, the bearing voltage in the second bearing 24 can be reduced.

A non-conductive member may be provided on the load side of the conductive shaft 21. In this case, the bearing voltage in the first bearing 23 can be reduced.

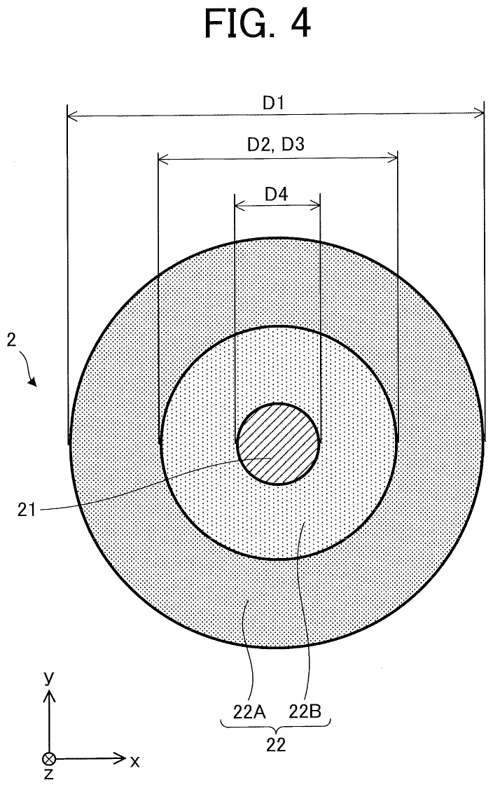

FIG. 4 is a cross-sectional view schematically showing the structure of the rotating body 22.

The rotating body 22 includes an outer rotor part 22A and an inner rotor part 22B provided inside the outer rotor part 22A. The outer rotor part 22A is ring-shaped. The outer rotor part 22A is disposed outside the inner rotor part 22B and is united with the inner rotor part 22B. The conductive shaft 21 is fixed inside the inner rotor part 22B.

D1 is the outer diameter of the outer rotor part 22A, D2 is the inner diameter of the outer rotor part 22A, D3 is the outer diameter of the inner rotor part 22B, and D4 is the inner diameter of the inner rotor part 22B. In the example shown in FIG. 4, D2=D3.

The outer rotor part 22A forms the magnetic poles of the rotor 2 (specifically, the rotating body 22). By applying a magnetic field to the outer rotor part 22A during the forming of the outer rotor part 22A, the outer rotor part 22A is oriented along the applied magnetic field. The orientation of the magnetic field is a polar anisotropic orientation. In the present embodiment, the outer rotor part 22A has alternating N and S poles in the circumferential direction. The rotating body 22 (specifically, the outer rotor part 22A) forms eight poles. The number of magnetic poles is not limited to eight. For example, the number of magnetic poles need only be two or more and need not necessarily be eight.

The outer rotor part 22A is disposed at the outermost circumference of the rotating body 22. The outer rotor part 22A is a bonded magnet. The inner rotor part 22B is an insulating material containing resin, elastomer, air, or the like.

The insulating material constituting the inner rotor part 22B is, for example, a resin such as a polyamide resin or polybutylene terephthalate. In the present embodiment, the inner rotor part 22B is a resin with a relative permittivity of 10 or less. When the resin constituting the inner rotor part 22B is a polyamide resin or polybutylene terephthalate, the inner rotor part 22B can be produced by injection molding, thereby increasing the degree of freedom of shape of the rotor 2.

The bonded magnet constituting the outer rotor part 22A is made of, for example, a complex containing resin and magnetic powder. For example, the bonded magnet can be obtained by injection molding the resin and magnetic powder. The magnetic powder used in the bonded magnet is, for example, ferrite, such as strontium ferrite (SrO-6Fe₂O₃) and barium ferrite (BaO-6F₂O₃). When the magnetic powder is ferrite, the cost of the rotor 2 can be reduced. The resin used for the bonded magnet is a thermoplastic resin such as a polyamide resin (6PA, 12PA, PA6T) or polyphenylene sulfide (PPS).

When the resin used for the bonded magnet is a polyamide resin, the rotor 2 (specifically, rotating body 22) with high mechanical strength and good heat resistance can be obtained. Also, 12PA yields a bonded magnet with less water absorption and smaller relative permittivity variation than 6PA. When the resin in the bonded magnet is constituted of polyphenylene sulfide (PPS), a rotor with low water absorption, small relative permittivity variation, and good dimensional stability can be obtained.

The relative permittivity of resin is in the range of 3 to 10. In contrast to this, the relative permittivity of ferrite is approximately 250, which is much larger than that of resin. Until now, the characteristic distribution of the relative permittivity of ferrite bonded magnets composed of resin with a small relative permittivity and ferrite with a large relative permittivity has not been focused on, nor has it been described in a characteristics table of magnets.

The measurement of the relative permittivity εr of a bonded magnet containing ferrite has been actually performed. To measure the relative permittivity, a dice-shaped square piece was fabricated, aluminum foil was attached to the opposite side of the square piece, the capacitance between the two ends was measured with an LCR meter, and then the relative permittivity was calculated from the results obtained using the following formula. It should be noted that the measurement conditions for the capacitance were a frequency of 16 kHz, a voltage of 1.5 V, and a temperature of 20° C.

$$ε r = C \times d / ( S \times {ε}_{0} )$$

C: capacitance [F], d: distance between opposing measurement surfaces [m], S: area of measurement surface [m²],
ε₀: dielectric constant of vacuum (8.854×10⁻¹² [F/m])

As a result of the above measurements, we found that the relative permittivity of bonded magnets containing ferrite of 32 samples with different conditions, such as the passage of time after molding, material lot, etc., is widely distributed in the range where the lower limit value is larger than 40 and the upper limit value is equal to or less than 200. In other words, the relative permittivity of bonded magnets has a significant effect on bearing voltage. For that reason, it is preferable that the outer rotor part 22A be a bonded magnet with a relative permittivity larger than 40 and equal to or less than 200.

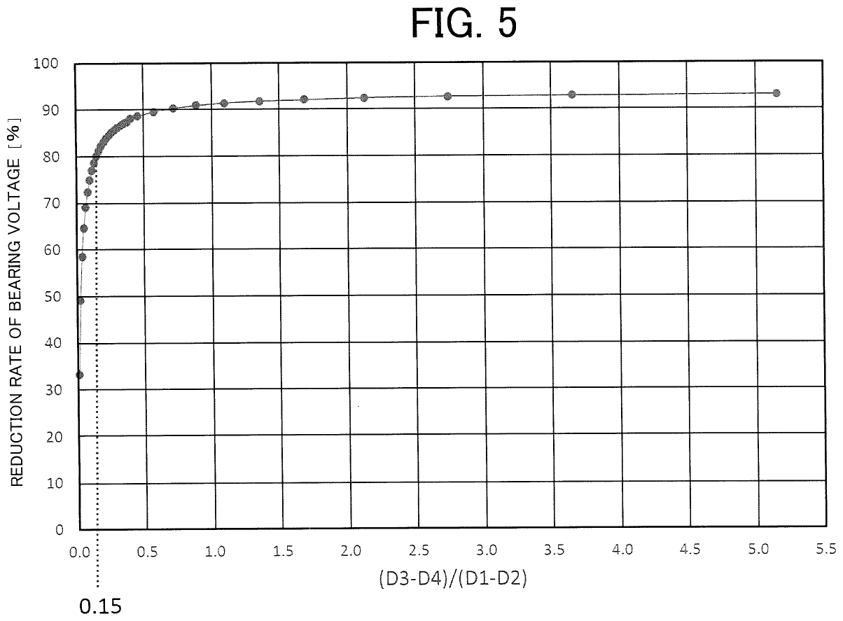

FIG. 5 is a graph showing the reduction rate of bearing voltage in the electric motor 1 according to the first embodiment with respect to an electric motor under comparison.

The horizontal axis indicates (D3−D4)/(D1−D2).

The vertical axis indicates the reduction rate of the bearing voltage in the electric motor 1 according to the present embodiment with respect to the bearing voltage in the electric motor under comparison. In other words, the vertical axis indicates that the larger the reduction rate, the smaller the bearing voltage, and the bearing voltage becomes 0 V at a reduction rate of 100%. In a comparable rotor, the rotating body has a ring shape with an outer diameter is Φ42 mm and an inner diameter is Φ8 mm, and the rotating body consists of a bonded magnet with a relative permittivity of 200. In other words, in the electric motor under comparison, the rotating body consists only of a bonded magnet.

As shown in FIG. 5, the reduction rate of the bearing voltage with respect to the comparable rotor varies almost linearly up to approximately 80%, and the rate of change decreases gradually in the range of a reduction rate of 80% or more. At a reduction rate of 80%, (D3−D4)/(D1−D2) is 0.15. Therefore, when (D3−D4)/(D1−D2) is 0.15 or more, the bearing voltage can be effectively reduced and the bearing life can be extended.

Therefore, the electric motor 1 satisfies D2=D3 and 0.15≤(D3−D4)/(D1−D2), where the outer diameter of the outer rotor part 22A is D1, the inner diameter of the outer rotor part 22A is D2, the outer diameter of the inner rotor part 22B is D3, and the inner diameter of the inner rotor part 22B is D4. This configuration allows the bearing voltage to be reduced, the discharge current flowing in the bearing can be suppressed, and the increase in vibration and noise of the electric motor 1 due to electrolytic corrosion of the first bearing 23 or the second bearing 24 can be suppressed.

### First Bearing 23

The first bearing 23 includes a first conductive inner ring 23A, a first conductive outer ring 23B, and two or more balls 23C. The two or more balls 23C are disposed between the first conductive inner ring 23A and the first conductive outer ring 23B. Each ball 23C is conductive. A lubricant is applied to each ball 23C. The lubricant applied to each ball 23C is non-conductive. The first conductive inner ring 23A, the first conductive outer ring 23B, and each ball 23C are made of, for example, metal, such as iron.

The first conductive inner ring 23A is fixed to the conductive shaft 21. That is, the first conductive inner ring 23A is in contact with the conductive shaft 21. The first conductive inner ring 23A is fixed to the conductive shaft 21 by, for example, press fit or adhesive. When the first conductive inner ring 23A rotates together with the conductive shaft 21, a thin oil film layer is formed between the outer peripheral surface, which is the raceway surface of the first conductive inner ring 23A, and each ball 23C, and a thin oil film layer is formed between the inner peripheral surface, which is the raceway surface of the first conductive outer ring 23B, and each ball 23C. As a result, the first conductive inner ring 23A and the first conductive outer ring 23B are electrically insulated from each ball 23C.

The outer diameter of the first bearing 23 (specifically, the first conductive outer ring 23B) is approximately equal to the inner diameter of a first housing 51 of the frame 5A. The first bearing 23 (specifically, the first conductive outer ring 23B) is fixed to the first housing 51 by, for example, press fit or adhesive. In the present embodiment, the first conductive outer ring 23B is in contact with the conductive housing 5. The first bearing 23 (specifically, the first conductive outer ring 23B) may be disposed in the first housing 51 by clearance fit.

### Second Bearing 24

The second bearing 24 includes a second conductive inner ring 24A, a second conductive outer ring 24B, and two or more balls 24C. The two or more balls 24C are disposed between the second conductive inner ring 24A and the second conductive outer ring 24B. Each ball 24C is conductive. A lubricant is applied to each ball 24C. The lubricant applied to each ball 24C is non-conductive. The second conductive inner ring 24A, the second conductive outer ring 24B, and each ball 24C are made of, for example, metal, such as iron.

The second conductive inner ring 24A is fixed to the non-conductive member 4 by, for example, press fit or adhesive. When the second conductive inner ring 24A rotates together with the conductive shaft 21 and the non-conductive member 4, a thin oil film layer is formed between the outer peripheral surface, which is the raceway surface of the second conductive inner ring 24A, and each ball 24C, and a thin oil film layer is formed between the inner peripheral surface, which is the raceway surface of the second conductive outer ring 24B, and each ball 24C. As a result, the second conductive inner ring 24A and the second conductive outer ring 24B are electrically insulated from each ball 24C.

The outer diameter of the second bearing 24 (specifically, the second conductive outer ring 24B) is approximately equal to the inner diameter of a second housing 52 of the bracket 5B. The second bearing 24 (specifically, the second conductive outer ring 24B) is fixed to the conductive housing 5 (specifically, the second housing 52 of the bracket 5B), for example, by press fit or adhesive. In the present embodiment, the second conductive outer ring 24B is in contact with the conductive housing 5. The second bearing 24 (specifically, the second conductive outer ring 24B) may be disposed in the conductive housing 5 (specifically, the second housing 52 of the bracket 5B) by clearance fit.

The thickness of the oil film layer is, for example, equal to or less than 1 μm, but the thickness of the oil film layer varies depending on several factors, such as the rotational speed of the rotor 2 or the temperature in the electric motor 1.

A preload spring is provided between the second bearing 24 and the bracket 5B (specifically, the second housing 52) to provide preload in the axial direction to the second bearing 24. Since the preload in the axial direction is provided to the first bearing 23 and the second bearing 24 by the preload spring, the rattling of the balls 23C and 24C during the rotation of the rotor 2 can be prevented.

In the present embodiment, the size of the first bearing 23 is equal to the size of the second bearing 24. Thus, the outer diameter (i.e., diameter) of the first conductive outer ring 23B is equal to the outer diameter (i.e., diameter) of the second conductive outer ring 24B. Each of the first bearing 23 and the second bearing 24 is, for example, a deep groove ball bearing of the bearing number 608 with an outer diameter of 22 mm, an inner diameter of 8 mm, and a width of 7 mm. In the present embodiment, the size of the first bearing 23 is equal to the size of the second bearing 24, but the size of the first bearing 23 may be different from that of the second bearing 24.

### Conductive Housing 5

As shown in FIG. 1, the conductive housing 5 includes the frame 5A in which the stator 3 and the rotor 2 are disposed and the bracket 5B that covers the interior of the frame 5A. In other words, the stator 3 and the rotor 2 are disposed in the conductive housing 5 (specifically, frame 5A). The conductive housing 5 is made of, for example, metal, such as iron.

The frame 5A is a conductive frame. The frame 5A is made of, for example, metal, such as iron. The inner surface of the frame 5A is mechanically and electrically connected to the outer peripheral surface of the stator core 31. The stator 3 is grounded through the frame 5A. The frame 5A is, for example, a cup-shaped frame. The frame 5A includes the first housing 51 in which the first bearing 23 is disposed. The first housing 51 is part of the frame 5A and is located at the bottom of the frame 5A. In the example shown in FIG. 1, the first housing 51 is part of the bottom of the frame 5A that projects in the axial direction and a direction perpendicular to the axial direction in the xy-plane. In the example shown in FIG. 1, the first conductive outer ring 23B of the first bearing 23 is in contact with the first housing 51.

The first housing 51 includes a through hole 51A, and the conductive shaft 21 protrudes to an area outside the frame 5A through the through hole 51A.

The bracket 5B is a conductive bracket. The bracket 5B is made of, for example, metal, such as iron. The frame 5A and the bracket 5B are electrically connected to each other. The bracket 5B includes the second housing 52 in which the second bearing 24 is disposed. Part of the bracket 5B other than the second housing 52 is, for example, a flat plate. The second housing 52 is part of the bracket 5B that projects in the axial direction from the flat plate. In the example shown in FIG. 1, the second conductive outer ring 24B of the second bearing 24 is in contact with the second housing 52.

Since the frame 5A and the bracket 5B are mechanically and electrically connected to each other, the first conductive outer ring 23B of the first bearing 23 and the second conductive outer ring 24B of the second bearing 24 can be made equipotential with a simple configuration, and thus the bearing voltage can be reduced.

As shown in FIG. 1, the conductive housing 5 may further include a circuitry cover 5C. The circuitry cover 5C is a conductive cover. The circuitry cover 5C is made of, for example, metal, such as iron. The circuitry cover 5C may be made of resin. As shown in FIG. 1, the circuitry cover 5C covers the electric circuitry 6. Specifically, the circuitry cover 5C covers the electric circuitry 6 together with the bracket 5B. In the present embodiment, the electric circuitry 6 is disposed in the conductive housing 5, but part or all of the electric circuitry 6 may be disposed outside the conductive housing 5.

As shown in FIG. 1, a circuitry case 5D may be disposed in the circuitry cover 5C to fix the electric circuitry 6. In this case, the circuitry case 5D is disposed in the circuitry cover 5C. The circuitry case 5D is fixed, for example, to the bracket 5B. The circuitry case 5D is a non-conductive case. The circuitry case 5D is made of, for example, non-conductive resin. For example, a concave part in which the electric circuitry 6 is disposed is formed in the circuitry case 5D by press molding.

Each of the frame 5A, the bracket 5B, and the circuitry cover 5C includes a flange 53 that forms an outer edge. The flanges 53 of the frame 5A, the bracket 5B, and the circuitry cover 5C are fixed to each other, for example, by a screw. Thus, the frame 5A, the bracket 5B, and the circuitry cover 5C are mechanically coupled together and electrically connected to each other. In other words, in the example shown in FIG. 1, the conductive housing 5 is divided by the bracket 5B into a motor housing section 54 in which the rotor 2 and the stator 3 are disposed and a circuit housing section 55 in which the electric circuitry 6 is disposed.

The frame 5A, the bracket 5B, and the circuitry cover 5C may be electrically connected to each other. In the present embodiment, the frame 5A and the bracket 5B are made of conductive material, but either the frame 5A or the bracket 5B may be made of non-conductive material such as non-conductive resin, or both the frame 5A and the bracket 5B may be made of non-conductive material such as non-conductive resin.

When the frame 5A is made of conductive material, a non-conductive member, such as a non-conductive resin, may be disposed between the first conductive inner ring 23A and the conductive shaft 21. This configuration can reduce the bearing voltage in the first bearing 23.

The non-conductive resin described above is, for example, a bulk molding compound resin (BMC resin) such as unsaturated polyester. In this case, the accuracy of the dimensions of the components can be enhanced, and the mechanical strength of the electric motor 1 can be increased.

### Connector 7

As shown in FIG. 1, the connector 7 is fixed to the circuitry cover 5C. The connector 7 includes wiring and a non-conductive cover covering the wiring, for example. The wiring of the connector 7 is connected to the electric circuitry 6.

### Second Embodiment

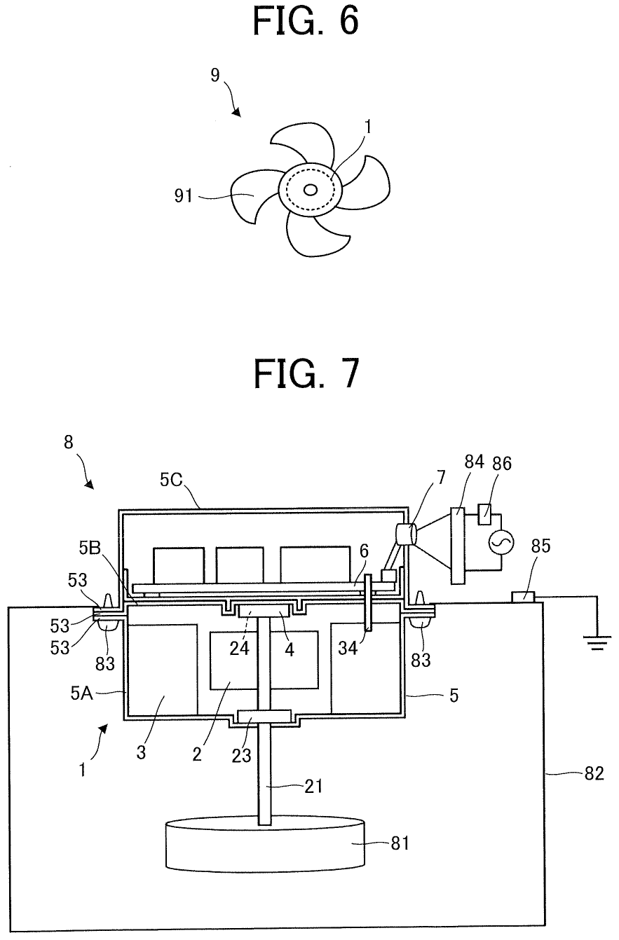

FIG. 6 is a diagram schematically showing a fan 9 according to a second embodiment.

The fan 9 includes a blade 91 and the electric motor 1. The fan 9 is also referred to as a blower. The blade 91 is formed of, for example, polypropylene (PP) containing glass fibers. The blade 91 is, for example, a sirocco fan, a propeller fan, a cross flow fan, or a turbo fan.

The electric motor 1 is the electric motor 1 according to the first embodiment. The blade 91 is fixed to the shaft of the electric motor 1. The electric motor 1 drives the blade 91. Specifically, the electric motor 1 rotates the blade 91. When the electric motor 1 is driven, the blade 91 rotates, thereby generating airflow. Accordingly, the fan 9 can send air.

Since the fan 9 according to the second embodiment includes the electric motor 1 according to the first embodiment, the same advantages described in the first embodiment can be obtained. In addition, the performance of the fan 9 can be maintained over a long period of time.

In addition, since the fan 9 according to the second embodiment includes the electric motor 1 according to the first embodiment, vibration and noise in the fan 9 can be reduced.

### Third Embodiment

FIG. 7 is a diagram schematically showing a ventilator 8 according to a third embodiment.

The ventilator 8 includes a blade 81 and the electric motor 1 that rotates the blade 81. The electric motor 1 is the electric motor 1 described in the first embodiment. The blade 81 is fixed to the load side of the conductive shaft 21 of the electric motor 1.

The ventilator 8 can be used in a wide range of uses such as residential use and commercial use. For example, the ventilator 8 is used for a living room, a kitchen, a bathroom, or a toilet in a residence. The blade 81 and at least part of the electric motor 1 are covered by a ventilator body 82. The conductive housing 5 of the electric motor 1 is fix to the ventilator body 82 by screws 83. The ventilator body 82 includes a power connection terminal block 84 and a ground connection terminal 85.

The connector 7 of the electric motor 1 is connected to the power connection terminal block 84. One of the external connection terminals of the power connection terminal block 84 is connected to one end of the power line of an AC power supply through a switch 86. The other end of the external connection terminals of the power connection terminal block 84 is directly connected to the other end of the power line of the AC power supply. In other words, the supply of power to the electric motor 1 is controlled by turning the switch 86 on and off. When the switch 86 is turned on, power is supplied to the electric motor 1, and the blade 81 fixed to the conductive shaft 21 of the electric motor 1 rotates to ventilate the room.

Since the ventilator 8 includes the electric motor 1 according to the first embodiment, the same advantages described in the first embodiment can be obtained. As a result, the performance of the ventilator 8 can be maintained over a long period of time.

In addition, since the ventilator 8 includes the electric motor 1 according to the first embodiment, vibration and noise in the ventilator 8 can be reduced.

The flange 53 of the conductive housing 5 is fixed to the ventilator body 82 of the ventilator 8 by the screws 83. The frame 5A of the electric motor 1 is disposed inside the ventilator body 82. The electric circuitry 6 of the electric motor 1 is disposed outside the ventilator body 82. The bracket 5B is disposed between the electric circuitry 6 and the rotor 2. Thus, the electric circuitry 6 is isolated from the rotor 2, and thus the electric circuitry 6 is less susceptible to the temperature and humidity inside the ventilator body 82. Therefore, the stable performance of the ventilator 8 can be maintained over a long period of time. As a result, increased noise in the ventilator 8 due to electrolytic corrosion of the first bearing 23 or the second bearing 24 can be prevented, and a comfortable space can be provided over the long term.

When the conductive housing 5 of the electric motor 1 is a metal housing, the strength of the electric motor 1 to hold the rotor 2 is increased. Therefore, when the conductive housing 5 of the electric motor 1 is a metal housing, a heavy blade, such as a large blade and a metal blade, can be applied to the blade 81.

### Fourth Embodiment

An air conditioner 10 (also referred to as a refrigerating and air conditioning apparatus or a refrigeration cycle apparatus) according to a fourth embodiment will be described.

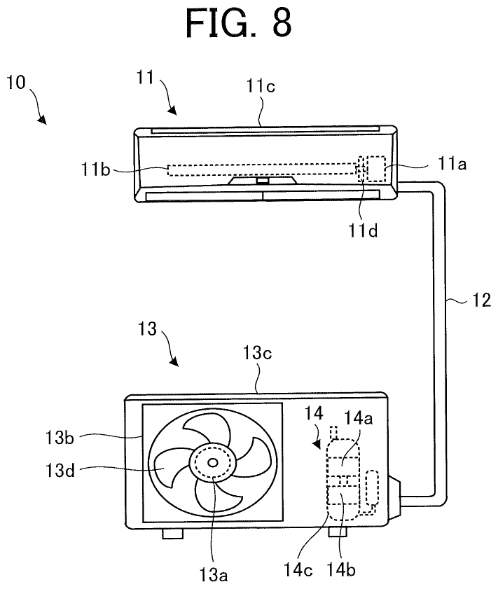

FIG. 8 is a diagram schematically showing the configuration of the air conditioner 10 according to the fourth embodiment.

The air conditioner 10 according to the fourth embodiment includes an indoor unit 11 as a blower (also referred to as a first blower) and an outdoor unit 13 as a blower (also referred to as a second blower) to be connected to the indoor unit 11.

In the present embodiment, the air conditioner 10 includes the indoor unit 11, a refrigerant piping 12, and the outdoor unit 13. For example, the outdoor unit 13 is connected to the indoor unit 11 through the refrigerant piping 12.

The indoor unit 11 includes an electric motor 11a (e.g., the electric motor 1 according to the first embodiment), a blowing unit 11b that sends air by being driven by the electric motor 11a, and a housing 11c that covers the electric motor 11a and the blowing unit 11b. The blowing unit 11b includes, for example, a blade 11d to be driven by the electric motor 11a. For example, the blade 11d is fixed to the shaft of the electric motor 11a and generates airflow.

The outdoor unit 13 includes an electric motor 13a (e.g., the electric motor 1 according to the first embodiment), a blowing unit 13b, a compressor 14, a heat exchanger (not shown), and a housing 13c that covers the blowing unit 13b, the compressor 14, and the heat exchanger. The blowing unit 13b is driven by the electric motor 13a and sends air. The blowing unit 13b includes, for example, a blade 13d to be driven by the electric motor 13a. For example, the blade 13d is fixed to the shaft of the electric motor 13a and generates airflow. The compressor 14 includes an electric motor 14a (e.g., the electric motor 1 according to the first embodiment), a compression mechanism 14b (e.g., a refrigerant circuit) to be driven by the electric motor 14a, and a housing 14c that covers the electric motor 14a and the compression mechanism 14b.

In the air conditioner 10, at least one of the indoor unit 11 or the outdoor unit 13 includes the electric motor 1 described in the first embodiment. That is, the indoor unit 11, the outdoor unit 13, or each of the indoor unit 11 and the outdoor unit 13 includes the electric motor 1 described in the first embodiment. Specifically, the electric motor 1 described in the first embodiment is applied to at least one of the electric motors 11a or 13a as a driving source of the blowing unit. In other words, the electric motor 1 described in the first embodiment is applied to the indoor unit 11, the outdoor unit 13, or each of the indoor unit 11 and the outdoor unit 13. The electric motor 1 described in the first embodiment may be applied to the electric motor 14a of the compressor 14.

The air conditioner 10 can perform air conditioning, for example, cooling operation in which cold air is blown from the indoor unit 11 or heating operation in which warm air is blown from the indoor unit 11. In the indoor unit 11, the electric motor 11a is a driving source for driving the blowing unit 11b. The blowing unit 11b can send conditioned air.

In the indoor unit 11, the electric motor 11a is fixed to the housing 11c of the indoor unit 11, for example, by a screw. In the outdoor unit 13, the electric motor 13a is fixed to the housing 13c of the outdoor unit 13, for example, by a screw.

In the air conditioner 10 according to the fourth embodiment, since the electric motor 1 described in the first embodiment is applied to at least one of the electric motors 11a or 13a, the same advantages as those described in the first embodiment can be obtained. As a result, the performance of the air conditioner 10 can be maintained over the long term.

In addition, when the electric motor 1 according to the first embodiment is used as the driving source of a blower (e.g., indoor unit 11), the same advantages described in the first embodiment can be obtained. As a result, the performance of the blower is maintained over the long term. The blower including the electric motor 1 according to the first embodiment and the blade (e.g., blade 11d or 13d) to be driven by the electric motor 1 can be used alone as a device to send air. The blower can also be applied to devices other than the air conditioner 10.

In addition, when the electric motor 1 according to the first embodiment is used as the driving source of the compressor 14, the same advantages described in the first embodiment can be obtained. As a result, the performance of the compressor 14 can be maintained over the long term.

In addition to the air conditioner 10, the electric motor 1 described in the first embodiment can be mounted on home appliances such as vacuum cleaners. Furthermore, the electric motor 1 described in the first embodiment can be installed in any electrical equipment that includes a driving source, such as machine tools, electric vehicles, drones, and robots.

The features in each embodiment described above can be combined with each other.

### DESCRIPTION OF REFERENCE CHARACTERS

1, 11a, 13a, 14a electric motor, 2 rotor, 3 stator, 4 non-conductive member, 5 conductive housing, 5A frame, 5B bracket, 6 electric circuitry, 7 connector, 8 ventilator, 9 fan, 10 air conditioner, 11 indoor unit, 12 refrigerant piping, 13 outdoor unit, 21 conductive shaft, 22 rotating body, 23 first bearing, 23A first conductive inner ring, 23B first conductive outer ring, 23C, 24C ball, 24 second bearing, 24A second conductive inner ring, 24B second conductive outer ring, 31 stator core, 32 insulator, 33 coil, 51 first housing, 52 second housing, 81, 91 blade.

1. A rotor comprising:
an outer rotor part; and
an inner rotor part provided inside the outer rotor part, wherein
the outer rotor part is a bonded magnet, a relative permittivity of the bonded magnet being larger than 40 and equal to or smaller than 200,
the inner rotor part is an insulating material, a relative permittivity of the insulating material being equal to or smaller than 10, and
the rotor satisfies D2=D3 and 0.15≤(D3−D4)/(D1−D2),
where D1 is an outer diameter of the outer rotor part, D2 is an inner diameter of the outer rotor part, D3 is an outer diameter of the inner rotor part, and D4 is an inner diameter of the inner rotor part.

2. The rotor according to claim 1, wherein the insulating material is a polyamide resin or polybutylene terephthalate.

3. The rotor according to claim 1, wherein
the bonded magnet contains magnetic powder and resin, and
the magnetic powder is ferrite.

4. The rotor according to claim 3, wherein
the resin in the bonded magnet is polyamide resin.

5. The rotor according to claim 3, wherein
the resin in the bonded magnet is polyphenylene sulfide.

6. An electric motor comprising:
a stator; and
the rotor according to claim 1 disposed inside the stator.

7. The electric motor according to claim 6 further comprising:
a conductive shaft fixed inside the inner rotor part;
a bearing rotatably supporting the conductive shaft; and
a conductive housing,
wherein the rotor and the stator are disposed in the conductive housing,
the outer peripheral surface of the stator is in contact with the conductive housing,
the bearing includes an inner ring and an outer ring, and
the outer ring is in contact with the conductive housing.

8. A fan comprising:
a blade; and
the electric motor according to claim 6 to rotate the blade.

9. A ventilator comprising:
a blade; and
the electric motor according to claim 6 to rotate the blade.

10. An air conditioner comprising:
an indoor unit; and
an outdoor unit to be connected to the indoor unit,
wherein the indoor unit, the outdoor unit, or each of the indoor unit and the outdoor unit includes the electric motor according to claim 6.

11. The rotor according to claim 2, wherein
the bonded magnet contains magnetic powder and resin, and
the magnetic powder is ferrite.
